(19) United States
(12) Patent Application Publication
(10) Pub. No.: US 2021/0103083 A1
(43) Pub. Date: Apr. 8, 2021

(54) METHOD FOR PRODUCING A RETARDATION FILM, AND RETARDATION FILM

(71) Applicant: SHARP KABUSHIKI KAISHA, Sakai City, Osaka (JP)

(72) Inventors: KOJI MURATA, Sakai City (JP); AKIRA SAKAI, Sakai City (JP); YUICHI KAWAHIRA, Sakai City (JP); MASAHIRO HASEGAWA, Sakai City (JP); TAKAKO KOIDE, Sakai City (JP); KOZO NAKAMURA, Sakai City (JP); KIYOSHI MINOURA, Sakai City (JP)

(21) Appl. No.: 16/319,461

(22) PCT Filed: Jul. 18, 2017
(86) PCT No.: PCT/JP2017/025840

§ 371 Date: Jan. 21, 2019

(30) Foreign Application Priority Data
Jul. 25, 2016 (JP) 2016-145377

(51) Int. Cl. G02B 5/30; C09K 19/56

(52) U.S. Cl. CPC G02B 5/3016; C09K 19/56

(57) ABSTRACT

The present invention provides a method for producing a retardation film excellent in retardation controllability against heat and the retardation film. The method for producing a retardation film includes, in the following order: fixing an alignment of liquid crystal compounds to form a retardation giving layer, and heating the retardation giving layer. Preferably, the heating is first heating and the method further includes second heating for heating the retardation giving layer after the first heating.

### TECHNICAL FIELD

The present invention relates to methods for producing a retardation film and retardation films. Specifically, the present invention relates to a method for producing a retardation film suitably used in a liquid crystal display device and a retardation film.

### BACKGROUND ART

Retardation films are optical films used for image display devices and used to compensate for color tones and viewing angles.

In recent liquid crystal display devices widely used in the field of image display devices, retardation films are typically used for optical compensation. For example, Patent Literature 1 discloses a retardation film including a polymer compound and an alignment controlling agent, wherein the polymer compound has a side chain which has one or more azo groups and/or cynnamate groups and three or more and ten or less of arylene groups, the side chain further has an optionally substituted amino group, or a hydrocarbon group at the terminal, a content of the polymer compound in the retardation film is 71% by mass or more, and an in-plane retardation of the film at wavelength of 550 nm is 10 nm or more and 200 nm or less.

### CITATION LIST

### Patent Literature

### Patent Literature 1: JP 2016-80965 A

### SUMMARY OF INVENTION

### Technical Problem

In production of liquid crystal display devices, which typically includes heating, retardation variation of a retardation film caused by heating needs to be controlled. In addition, liquid crystal display devices, which are used in various places such as outdoors, need to be designed to cause no change in display properties in any environment. Thus, a retardation film has been required which is excellent in retardation controllability and is less likely to cause retardation variation by heating.

FIG. 10 is a flowchart showing a production process of a retardation film of Patent Literature 1. FIG. 11 is a schematic cross-sectional view of the retardation film of Patent Literature 1. As shown in FIG. 10 and FIG. 11, in an example of Patent Literature 1, a retardation film 1a including a supporter 10a, an alignment film 20a, and a layer 30a including the composition for retardation film is produced by sequentially performing forming an alignment film on a supporter, coating the alignment film with a composition for retardation film, pre-baking the photoalignment material (solvent removing), and irradiating the film with ultraviolet rays. Unfortunately, Patent Literature 1 fails to disclose a technique for controlling retardation variation by heat.

The present invention has been made under the current situation in the art and aims to provide a method for producing a retardation film excellent in retardation controllability against heat and the retardation film.

### Solution to Problem

The present inventors made various studies on methods for producing a retardation film excellent in retardation controllability against heat and retardation films. Then, they found that, in order to improve the retardation controllability against heat, heating a retardation giving layer after fixing the retardation giving layer is effective. Thereby, they found that the above problem can be successfully solved to arrive at the present invention.

In other words, an aspect of the present invention may be a method for producing a retardation film, including in the following order: fixing an alignment of liquid crystal compounds to form a retardation giving layer, and heating the retardation giving layer.

The heating may be performed to reduce a retardation Re of the retardation film by 5% to 25%.

The heating may be performed at a temperature of 180° C. to 220° C.

The heating may be first heating, and the method for producing a retardation film may further include second heating for heating the retardation giving layer after the first heating.

The second heating may be performed at a temperature not lower than the heating temperature in the first heating and not higher than 250° C.

In the fixing, the liquid crystal compounds may be irradiated with light.

The method for producing a retardation film may further include, before the fixing, coating a supporter with a liquid crystal composition containing the liquid crystal compounds.

The method for producing a retardation film may further include, before the coating, alignment treating of the supporter.

The supporter may include a substrate and a photoalignment film on the substrate, and the alignment treating may include photoalignment treatment on the photoalignment film.

The liquid crystal composition may further contain a solvent, and the method for producing a retardation film further includes removing the solvent between the coating and the fixing.

Another aspect of the present invention may be a retardation film produced by the method for producing a retardation film.

The retardation film may have a contrast ratio of not lower than 4000.

The retardation film may have a retardation Re of λ/4.

The retardation film may include a substrate, an alignment film on the substrate, and the retardation giving layer on the alignment film.

The alignment film may be a photoalignment film.

### Advantageous Effects of Invention

The present invention can provide a method for producing a retardation film excellent in retardation controllability against heat and the retardation film.

### BRIEF DESCRIPTION OF DRAWINGS

FIG. 1 is a flowchart showing a method for producing a retardation film of Embodiment 1.

FIG. 2 is a schematic cross-sectional view of a retardation film of Embodiment 2.

FIG. 3 includes schematic cross-sectional views of a retardation film of Embodiment 2 after the respective heating processes and a graph showing the relationship between the retardation versus the contrast ratio.

FIG. 4 is a flowchart showing a method for producing a retardation film of Example 1-1A.

FIG. 5 is a graph plotted with the normalized Re values of retardation films produced in Example 1 according to the heating time in the heating.

FIG. 6 is a graph showing the relationship between the retardation and the contrast ratio of a retardation film of Example 2-1 before and after the second heating.

FIG. 7 is a microscope photograph of the retardation film of Example 2-1 after the second heating.

FIG. 8 is a microscope photograph of the retardation film of Example 2-1 before the second heating.

FIG. 9 is a graph plotted with the normalized Re values of retardation films produced in Example 3 according to the heating time in the heating.

FIG. 10 is a flowchart showing a production process of a retardation film of Patent Literature 1.

FIG. 11 is a schematic cross-sectional view of the retardation film of Patent Literature 1.

### DESCRIPTION OF EMBODIMENTS

The present invention is described below in more detail based on embodiments with reference to the drawings.

The embodiments, however, are not intended to limit the scope of the present invention. The configurations employed in the embodiments may appropriately be combined or modified within the spirit of the present invention.

A retardation Re of λ/4 herein means an in-plane retardation of a ¼ wavelength (specifically 137.5 nm) provided at least to light with a wavelength of 550 nm and may be an in-plane retardation of not less than 100 nm and not more than 176 nm. Here, light with a wavelength of 550 nm is light with a wavelength to which the human luminosity is the highest.

### Embodiment 1

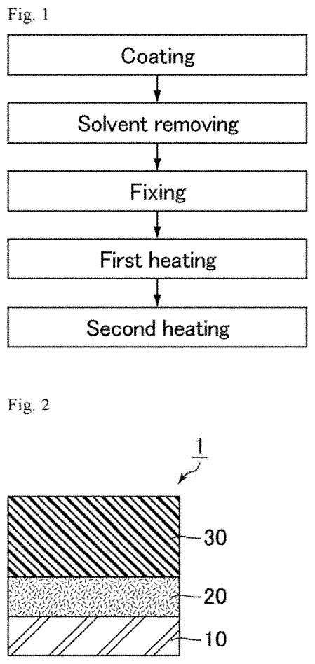

FIG. 1 is a flowchart showing a method for producing a retardation film of Embodiment 1. As shown in FIG. 1, the method for producing a retardation film of the present embodiment includes coating a supporter with a liquid crystal composition containing liquid crystal compounds and a solvent, removing the solvent, fixing the alignment of the liquid crystal compounds to form a retardation giving layer, first heating for heating the retardation giving layer, and second heating for heating the retardation giving layer. The following is description of each step.

The method for producing a retardation film of the present invention may be appropriately modified and is not limited to the conditions described in the present embodiment. For example, the steps excluding the fixing and the first heating may be omitted. For example, the coating and the removing the solvent may be omitted by transferring a layer including liquid crystal compounds formed on a different substrate to the supporter using a pressure-sensitive adhesive or an adhesive.

### <Coating>

The method for producing a retardation film of the present embodiment includes coating a supporter with a liquid crystal composition containing liquid crystal compounds and a solvent. This achieves production of retardation films with desired optical properties using various liquid crystal compounds.

When the supporter is coated with the liquid crystal composition in the coating in the present embodiment, any one of methods including the spin coating, roll coating, printing, dip coating, die coating, casting, bar coating, blade coating, spray coating, gravure coating, reverse coating, and extrusion coating may be employed. Among these, spin coating is preferred.

In the coating, the coating layer of the liquid crystal composition is preferably formed to have a sufficient thickness such that the retardation Re of the retardation giving layer to be formed in the later described fixing is sufficiently higher than the retardation Re required for the resulting retardation film. The retardation Re means an in-plane retardation and is expressed by the following formula (R).

Retardation Re=Δn×d formula (R)

The formula (R) satisfies Δn=nx−ny, where nx and ny each indicate the principal refractive index (nx>ny) in the plane of the retardation film, and d indicates the thickness (nm).

The liquid crystal compounds give a liquid crystal phase in a certain temperature range and may be compounds typically used in the field of retardation films. The liquid crystal compounds are preferably reactive liquid crystal compounds (reactive mesogen (RM)), more preferably polymerizable liquid crystal compounds. The alignment of the reactive liquid crystal compounds is fixed by irradiation with light, heat, or an electron beam. The alignment of the polymerizable liquid crystal compounds is fixed through polymerization of the compounds by irradiation with light, heat, or an electron beam. The polymerizable liquid crystal compounds may be polymerized by heat energy and is preferably polymerized by light irradiation.

Examples of the polymerizable liquid crystal compounds include polymerizable liquid crystal monomers, polymerizable liquid crystal oligomers, and polymerizable liquid crystal polymers. These may be used in mixture.

Preferred among the above examples for the polymerizable liquid crystal compounds are polymerizable liquid crystal monomers because they are highly sensitive during alignment treatment and are easily aligned at a desired angle (in a desired direction).

The solvent may be any solvent that can dissolve the liquid crystal compound. One or two or more solvents may be used. Examples of the solvent include propylene glycol monomethyl ether acetate (PGMEA), cyclopentanone, and methyl isobutyl ketone (MIBK). Preferably, one of these or a mixture of two or more of these is used.

The liquid crystal composition may further contain a polymerization initiator and/or an alignment controlling agent in addition to the liquid crystal compounds and the solvent.

When the polymerizable liquid crystal compounds are polymerized with electron beam irradiation, a polymerization initiator is unnecessary in some cases. When the polymerization is performed by a conventionally known method such as ultraviolet (UV) irradiation, for example, a polymerization initiator is typically used to promote the polymerization.

The alignment controlling agent influences the alignment of the liquid crystal compounds in the retardation giving layer or the like, and examples thereof include a compound including a 1,3,5-triazine ring. The alignment controlling agent may be one described in Patent Literature 1, for example.

The liquid crystal composition may contain a polymer compound not belonging to the liquid crystal compound, i.e., a polymer compound not having liquid crystal properties. For example, the polymer compounds disclosed in Patent Literature 1 may be used.

The supporter to be coated with the liquid crystal composition may be any product having a surface that supports the applied liquid crystal composition and preferably has transparency. The supporter includes a substrate and optionally an alignment film.

Examples of the substrate include polymer films, glass plates, and quartz plates. The thickness of the substrate is preferably 0.5 mm to 0.7 mm in the case of a glass plate or a quartz plate and preferably 0.1 mm to 0.3 mm in the case of a polymer film.

Examples of the alignment film include photoalignment films and rubbing alignment films. The thickness of the alignment film is preferably 50 nm to 200 nm, more preferably 80 nm to 120 nm.

### <Removing Solvent>

The method for producing a retardation film of the present embodiment includes removing the solvent (pre-baking). In the removing the solvent, at least part of the solvent in the liquid crystal composition is removed. This allows the liquid crystal compounds to be more likely fixed.

In the removing the solvent, air-drying, heating, depressuring, or combination of these may be employed.

When the removing the solvent is performed by heating, the heating temperature is preferably 50° C. to 130° C., more preferably 60° C. to 120° C., still more preferably 70° C. to 110° C. The heating time in the removing the solvent is preferably 10 seconds to 600 seconds, more preferably 30 seconds to 300 seconds, still more preferably 60 seconds to 100 seconds.

### <Fixing>

The method for producing a retardation film of the present embodiment includes fixing the alignment of the liquid crystal compounds to form a retardation giving layer. In the fixing, for example, polymerizable liquid crystal compounds are polymerized (cured) by heat or light, whereby the alignment of the compounds is fixed and a retardation giving layer is formed. The fixing is preferably performed by irradiating the liquid crystal compounds with light. This achieves efficient fixing of the liquid crystal compounds at low temperatures.

When the polymerizable liquid crystal compounds are polymerized by light, typically ultraviolet rays or visible light rays, preferably ultraviolet rays are used. The wavelength of ultraviolet rays used for polymerization of the polymerizable liquid crystal compounds is preferably 260 nm to 390 nm, more preferably 280 nm to 370 nm, still more preferably 300 nm to 350 nm. The irradiation dose of ultraviolet rays is preferably 30 mJ/cm² to 200 mJ/cm², more preferably 70 mJ/cm² to 130 mJ/cm².

Light for polymerization of the polymerizable liquid crystal compounds may be polarized light or unpolarized light, preferably unpolarized light. The light for polymerization of the polymerizable liquid crystal compounds may be from a product such as a low pressure mercury lamp, a medium pressure mercury lamp, a high pressure mercury lamp, an extra high pressure mercury lamp, a xenon lamp, a metal halide lamp, an electrodeless lamp, or an LED lamp.

The compound in the retardation giving layer may have no liquid crystal properties at this stage. For example, when polymerizable liquid crystal monomers are used for producing the retardation giving layer, the polymerizable liquid crystal monomers are fixed in the process of forming the retardation giving layer, whereby the compound in the retardation giving layer may lose liquid crystal properties.

### <First Heating>

The method for producing a retardation film of the present embodiment includes first heating for heating the retardation giving layer. Performing the first heating after the fixing achieves production of a retardation film excellent in retardation controllability against heat. For example, the produced retardation film can give a small variation in retardation Re at temperatures for production of liquid crystal display devices and for typical use of the liquid crystal display devices.

The first heating is performed to reduce the retardation Re of the retardation film by preferably 5% to 25%, more preferably 5% to 20%, still more preferably 10% to 20%. Such first heating allows production of a retardation film more excellent in retardation controllability against heat.

The heating temperature in the first heating is preferably 180° C. to 220° C., more preferably 180° C. to 215° C., still more preferably 180° C. to 210° C., particularly preferably 200° C. to 210° C. The heating time in the first heating is preferably 10 minutes to 150 minutes, more preferably 15 minutes to 80 minutes, still more preferably 30 minutes to 60 minutes. A heating temperature in the first heating of lower than 180° C. may fail in sufficiently improving the retardation controllability, possibly failing in providing heat durability. A heating temperature of higher than 220° C. may fail in sufficiently increasing the contrast ratio. Setting the upper limit of the heating temperature at 220° C., which substantially corresponds to the upper limit of the heating temperatures in the production process of liquid crystal display devices, achieves particularly excellent retardation controllability at temperatures for production process of liquid crystal display devices.

The first heating is performed preferably at 180° C. to 220° C. for 10 minutes to 150 minutes, more preferably at 180° C. to 215° C. for 15 minutes to 80 minutes, still more preferably at 180° C. to 210° C. for 30 minutes to 60 minutes.

### <Second Heating>

The method for producing a retardation film of the present embodiment includes, in addition to the first heating, second heating for heating the retardation giving layer. Performing the second heating improves the alignment of microdomains in the retardation giving layer to increase the contrast ratio of the retardation film.

Here, performing only the first heating can presumably improve the retardation controllability against heat and increase the contrast ratio. Still, the alignment of microdomains in the retardation giving layer is more improved through gradual heating to the retardation giving layer than through rapid heating thereto. Accordingly, gradual heating with the first heating followed by the second heating presumably provides a retardation film excellent in retardation controllability against heat and having a higher contrast ratio. Similarly, the first heating sufficiently improves the retardation controllability. Still, performing the second heating, which further reduces the retardation Re, can further suppress the change of retardation Re caused by production of the liquid crystal display device and typical using environments.

When the second heating is performed without the first heating, the retardation Re rapidly reduces, possibly significantly deteriorating the retardation controllability of the retardation film. Thus, in order to increase the retardation controllability against heat and the contrast ratio, the second heating is preferably performed after the first heating as in the present embodiment.

When a conventional liquid crystal display device is used outdoors, reflection of external light increases inside and on the surface of the liquid crystal display device, which may reduce the visibility (the contrast ratio may decrease to cause a whitely faded display surface). In order to improve the outdoor visibility, low-reflective liquid crystal display devices have been developed. Unfortunately, some low-reflective liquid crystal display devices have a low contrast ratio in a dark room. Patent Literature 1 discloses that the contrast ratio is increased by modifying the materials used for the retardation film. However, only modification of the materials cannot achieve sufficient increase in contrast ratio.

The present inventors found that improving the depolarization of the retardation giving layer in a retardation film is effective for achieving a high contrast ratio and that performing the first heating and the second heating can increase the contrast ratio as well as the retardation controllability. Accordingly, a retardation film produced by the method for producing a retardation film of the present embodiment is suitably used to increase the contrast ratio in a dark room, which is an object of low-reflective liquid crystal display devices with enhanced outdoor visibility.

The second heating is performed preferably at a temperature not lower than the heating temperature in the first heating and not higher than 250° C., more preferably at a temperature not lower than the heating temperature in the first heating and not higher than 240° C., still more preferably at a temperature not lower than the heating temperature in the first heating and at 210° C. to 240° C., particularly preferably at a temperature not lower than the heating temperature in the first heating and at 220° C. to 240° C. Such second heating can more increase the contrast ratio of the retardation film.

The heating time in the second heating may be appropriately set such that the retardation film after the second heating has a desired retardation Re. As the heating temperature in the second heating is higher, the heating time in the second heating is preferably set to be shorter. Specifically, for example, the heating time may be 20 minutes to 500 minutes, 30 minutes to 400 minutes, or 50 minutes to 300 minutes.

The second heating is performed preferably at a temperature not lower than the heating temperature in the first heating and not higher than 250° C. for 20 minutes to 500 minutes, more preferably at a temperature not lower than the heating temperature in the first heating and not higher than 240° C. for 30 minutes to 400 minutes, still more preferably at a temperature not lower than the heating temperature in the first heating and at 210° C. to 240° C. for 50 minutes to 300 minutes, particularly preferably at a temperature not lower than the heating temperature in the first heating and at 220° C. to 240° C. for 50 minutes to 300 minutes.

### <Alignment Treating>

The method for producing a retardation film of the present embodiment may further include, before the coating, alignment treating of the supporter. This can further improve the alignment of the liquid crystal compounds in the retardation giving layer.

When the supporter includes an alignment film, examples of a method for alignment treating include the rubbing alignment treatment including rubbing the surface of an alignment film with a means such as a roller and the photoalignment treatment including irradiating the film with light. The material of the alignment film is not particularly limited and may be a conventionally known material. The alignment film may be subjected to any conventionally known alignment treatment. The rubbing alignment treatment may be performed directly on a substrate without disposing an alignment film on the substrate.

The alignment treating is preferably performed by the photoalignment treatment to a photoalignment film. This achieves alignment treatment without touching the surface of the photoalignment film, thereby reducing the waste generated by the alignment treatment.

### Embodiment 2

Embodiment 2 is a retardation film produced by the method for producing a retardation film of Embodiment 1. In the present embodiment, features unique to the present embodiment are mainly described and similar description as in Embodiment 1 is appropriately omitted.

FIG. 2 is a schematic cross-sectional view of a retardation film of Embodiment 2. As shown in FIG. 2, a retardation film 1 sequentially includes a substrate 10 as a supporter, an alignment film 20, and a retardation giving layer 30.

The retardation film 1 with a retardation of λ/4 has a contrast ratio of preferably not lower than 4000, more preferably 4000 to 20000 (maximum value). This can further increase the contrast ratio of the liquid crystal display device. The contrast ratio of the retardation film 1 preferably has an upper limit equal to the upper limit of the contrast ratio of two polarizers without a retardation giving layer used for contrast ratio measurement of the retardation film 1, i.e., the maximum value (measureable maximum value) as mentioned above. The contrast ratio of the two polarizers without a retardation giving layer was actually calculated from the following formula (1). The contrast ratio thereof was about 20000 (maximum value).

Contrast ratio of polarizers=(white luminance with two polarizers disposed in parallel Nicols)÷(black luminance with two polarizers disposed in crossed Nicols) Formula (1):

The contrast ratio (also referred to as CR) of the retardation film 1 is calculated based on the definition of the following formula (2).

Contrast ratio of retardation film 1=(white luminance with two polarizers disposed in parallel Nicols and holding the retardation film in between)÷(black luminance with two polarizers disposed in crossed Nicols and holding the retardation film in between) Formula (2):

In the formula (2), the white luminance was measured with the slow axis of the retardation film 1 disposed parallel to the polarization axes of the both polarizers, and the black luminance was measured with the slow axis of the retardation film 1 disposed parallel to the polarization axis of one of the polarizers. The retardation film 1 with a retardation of λ/4 may have the contrast ratio of not more than 6000 or not more than 5000.

The retardation film 1 of the present embodiment preferably has a retardation Re of λ/4. This allows the retardation film 1 to convert linearly polarized light into circularly polarized light.

The alignment film 20 of the present embodiment is preferably a photoalignment film. This achieves alignment treatment without touching the surface of the alignment film 20, thereby reducing the waste generated by the alignment treatment.

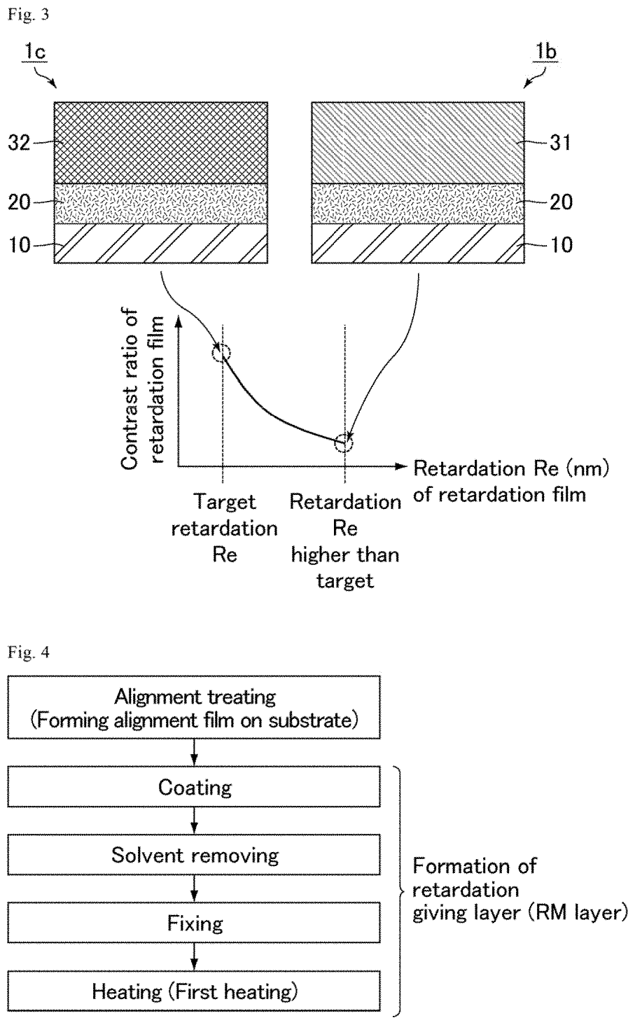

FIG. 3 includes schematic cross-sectional views of a retardation film of Embodiment 2 after the respective heating processes and a graph showing the relationship between the retardation versus the contrast ratio. The graph shown in FIG. 3 shows the relationship between the retardation Re versus the contrast ratio of a retardation film after the first heating and a retardation film after the second heating.

A retardation film 1b after the first heating sequentially includes the substrate 10, the alignment film 20, and a retardation giving layer 31 with microdomains before alignment treatment. A retardation film 1c after the second heating sequentially includes the substrate 10, the alignment film 20, and a retardation giving layer 32 with microdomains after alignment treatment.

Considering the variation in retardation Re in the second heating, the retardation Re of the retardation film 1b after the first heating is controlled to be higher than the target retardation Re of the retardation film 1c after the second heating. The retardation film 1c after the second heating has a higher contrast ratio than the retardation film 1b after the first heating. As shown in FIG. 3, forming a retardation giving layer under consideration of the reduction in retardation Re caused by the second heating can provide a retardation film with a desired retardation Re and a high contrast ratio after the first heating and the second heating.

The retardation film 1 of the present embodiment is excellent in retardation controllability against heat. Thus, variation in retardation Re caused by heating can be prevented even in formation of a layer of polyimide or polystyrene on the retardation film 1 of the present embodiment.

The present invention described in more detail with respect to examples which are not intended to limit the present invention.

### Example 1

### <Production of Retardation Film 1-1A of Example 1-1A>

FIG. 4 is a flowchart showing a method for producing a retardation film of Example 1-1A. In Example 1-1A, a retardation film was produced by sequentially performing coating a substrate with an alignment film followed by alignment treating of the alignment film, coating the alignment film with a liquid crystal composition containing liquid crystal compounds and a solvent, removing the solvent (pre-baking), fixing the alignment of the liquid crystal compounds to form a retardation giving layer, and heating (first heating) the retardation giving layer. The following is description of each step.

### <<Alignment Treating>>

A 0.7-mm-thick glass substrate was coated with a photoalignment material including a photofunctional group derived from an acrylic monomer by spin coating at 2000 rpm/12 sec such that the thickness was about 100 nm. Then, the photoalignment material was heated at 60° C. for 90 seconds to remove the solvent. Next, the photoalignment material was irradiated with polarized ultraviolet rays with a wavelength of 365 nm at a ultraviolet irradiation dose of 2 J/cm², followed by pre-baking at 180° C. for 20 minutes and post-baking at 220° C. for 40 minutes. Thereby, a photoalignment film was formed on the glass substrate.

### <<Coating>>

A liquid crystal composition containing polymerizable liquid crystal monomers that are a reactive mesogen and a solvent was prepared. The liquid crystal composition was applied to the alignment film by spin coating at 2000 rpm/12 sec such that the thickness after removing the solvent was about 1.0 μm. The liquid crystal composition applied to the alignment film and having a thickness of about 1.0 μm had a retardation Re of about 180 nm.

### <<Solvent Removing>>

The liquid crystal composition was heated at 90° C. for 80 seconds to remove the solvent in the liquid crystal composition.

### <<Fixing>>

The polymerizable liquid crystal monomers were irradiated with unpolarized ultraviolet rays with a wavelength of 313 nm at a ultraviolet irradiation dose of 100 mJ to fix the alignment of the polymerizable liquid crystal monomers, whereby a retardation giving layer was formed.

### <<Heating (First Heating)>>

The retardation giving layer was heated at 210° C. for 15 minutes, whereby the retardation film 1-1A of Example 1-1A was obtained.

### <Retardation of Retardation Film 1-1A of Example 1-1A>

The value obtained by dividing the retardation Re value of the resulting retardation film 1-1A by the retardation Re value of the retardation film before heating was about 0.87. In other words, the retardation Re value of the retardation film 1-1A was reduced through the heating by about 13%.

The value obtained by dividing the retardation Re value of the retardation film after the heating by the retardation Re value of the retardation film before heating is also referred to as a normalized Re. The reduction percentage of the retardation Re value after the heating from the retardation Re value before heating is also referred to as a retardation drop. Namely, the retardation drop of the retardation film 1-1A was about 13%.

### <Production of Retardation Films 1-1B to 1-1D of Examples 1-1B to 1-1D>

Retardation films 1-1B to 1-1D of Examples 1-1B to 1-1D were produced as in Example 1-1A except that the heating time in the heating was changed to 30 minutes, 40 minutes, or 80 minutes.

### <Retardation of Retardation Films 1-1B to 1-1D of Examples 1-1B to 1-1D>

The obtained retardation films 1-1B, 1-1C, and 1-1D had normalized Re values of about 0.84, about 0.83, and about 0.80, respectively. That is, the retardation Re values of the retardation films 1-1B, 1-1C, and 1-1D were reduced through the heating by about 16%, about 17%, and about 20%, respectively.

### <Production of Retardation Films 1-2A to 1-2D of Examples 1-2A to 1-2D>

Retardation films 1-2A to 1-2D of Examples 1-2A to 1-2D with a thickness of about 0.9 μm were produced as in Examples 1-1A to 1-1D except that, in the coating, the amount of the liquid crystal composition was changed to 2500 rpm/12 sec.

### <Retardation of Retardation Films 1-2A to 1-2D of Examples 1-2A to 1-2D>

The obtained retardation films 1-2A, 1-2B, 1-2C, and 1-2D had normalized Re values of about 0.87, about 0.84, about 0.83, and about 0.80, respectively. That is, the retardation Re values of the retardation films 1-2A, 1-2B, 1-2C, and 1-2D were reduced through the heating by about 13%, about 16%, about 17%, and about 20%, respectively.

### <Production of Retardation Films 1-3A to 1-3D of Examples 1-3A to 1-3D>

Retardation films 1-3A to 1-3D of Examples 1-3A to 1-3D with a thickness of about 0.8 μm were produced as in Examples 1-1A to 1-1D except that, in the coating, the amount of the liquid crystal composition was changed to 3000 rpm/12 sec.

### <Retardation of Retardation Films 1-3A to 1-3D of Examples 1-3A to 1-3D>

The obtained retardation films 1-3A, 1-3B, 1-3C, and 1-3D had normalized Re values of about 0.87, about 0.84, about 0.83, and about 0.80, respectively. That is, the retardation Re values of the retardation films 1-3A, 1-3B, 1-3C, and 1-3D were reduced through the heating by about 13%, about 16%, about 17%, and about 20%, respectively.

### <Evaluation for Retardation Controllability Against Heat>

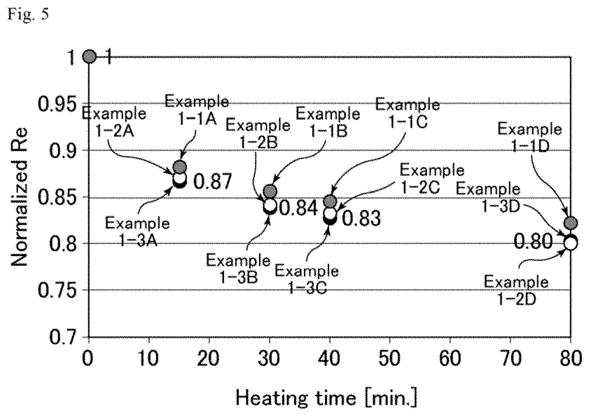

FIG. 5 is a graph plotted with the normalized Re values of the retardation films produced in Example 1 according to the heating time in the heating.

As shown in FIG. 5, the results of Examples 1-1A, 1-2A, and 1-3A indicate that heating time of 15 minutes causes a retardation drop of about 13% while the results of Examples 1-1B, 1-2B, and 1-3B indicate that heating time of 30 minutes causes a retardation drop of about 16%. This means that when the retardation film was heated for 30 minutes, the retardation drop was as low as about 3% in the latter 15 minutes of the heating. Accordingly, heating of at least 30 minutes achieves better retardation controllability of the retardation film.

Also, the results of Examples 1-1C, 1-2C, and 1-3C shown in FIG. 5 indicate that heating time of 40 minutes causes a retardation drop of about 17%. Thus, in the last 10 minutes of the 40-minutes heating time, the retardation drop was as low as about 1%.

Furthermore, the results of Examples 1-1D, 1-2D, and 1-3D shown in FIG. 5 indicate that the retardation Re of the retardation films after heating for 80 minutes was about 80% of the retardation Re before heating, i.e., the retardation drop was about 20%.

In Example 1, fixing for forming a retardation giving layer was followed by heating the retardation giving layer, whereby the retardation drop of the retardation film at high temperatures was able to be gradually suppressed. This provided a retardation film excellent in retardation controllability against heat. Also, performing the first heating is effective for precisely designing a retardation film with a high contrast ratio by performing the later described second heating.

### Example 2-1

### <Retardation Film 2-1 of Example 2-1>

The retardation film 1-1B produced in Example 1-1B was further heated at 220° C. for 250 minutes to perform the second heating, whereby a retardation film 2-1 of Example 2-1 was obtained.

### <Contrast Ratio Evaluation>

The retardation Re and the contrast ratio of the retardation film 2-1 of Example 2-1 were measured before and after the second heating. The contrast ratio of the retardation film was calculated according to the definition in the formula (2). For measurement of the contrast ratio of the retardation film, the mentioned two polarizers without a retardation giving layer (contrast ratio: about 20000) were used. The luminance was measured with a spectroradiometer for ultra-low luminance SR-UL1 available from Topcon.

The retardation Re value of the retardation film before the second heating was 166 nm, and the retardation Re value after the second heating was 133 nm.

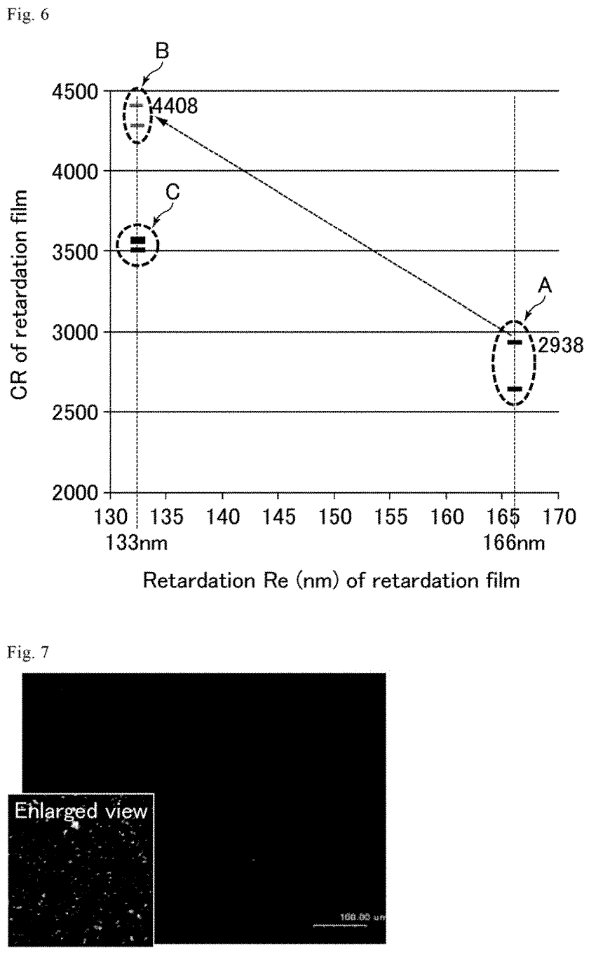

FIG. 6 is a graph showing the relationship between the retardation and the contrast ratio of the retardation film of Example 2-1 before and after the second heating. In FIG. 6, two plotted points within a region A are data from retardation films before the second heating. In FIG. 6, two plotted points within a region B are data from retardation films 2-1 obtained by heating sample retardation films of the region A at 220° C. for 250 minutes as the second heating. For reference, three sample films, which were produced without the second heating and had similar retardation Re values to those of the retardation films 2-1 of the region B, were measured for the contrast ratio and the results were plotted within a region C in FIG. 6. In measurement of the contrast ratio, a few samples were prepared and the contrast ratio of each sample was measured once. Thus, the regions A to C in FIG. 6 include several plotted points.

The retardation films before the second heating, whose data are plotted within the regions A and C in FIG. 6, are discussed. The films before the second heating had a contrast ratio of 2938 at a retardation Re value of 166 nm and a contrast ratio of 3550 at a retardation Re value of 133 nm. Thus, even retardation giving layers formed from the same material have different contrast ratios when having different retardation Re values (a retardation film with a smaller retardation Re value has a higher contrast ratio). In other words, the contrast ratio is a function of the retardation Re.

A retardation film before and after the second heating, whose data are plotted within the regions A and B in FIG. 6, is discussed. The retardation film before the second heating had a retardation Re value of 166 nm and a contrast ratio of 2938. Meanwhile, the retardation film after the second heating had a retardation Re value of 133 nm and a contrast ratio of 4408. Thus, the second heating significantly improved the contrast ratio of the retardation film.

The contrast ratio (4408) of the sample after the second heating, whose data are plotted within the region B, was higher than the contrast ratio (3550) of the sample that was produced without the second heating and had the same retardation Re value as the sample in the region C. In retardation films produced through the same steps, the contrast ratio is a function of the retardation Re, and a retardation film with a smaller retardation Re value has a higher contrast ratio. Here, comparison of contrast ratios of samples with the same retardation Re value showed that the second heating contributes to improvement in contrast ratio. The retardation film of Example 2-1 was adjusted to have a retardation Re value after the second heating of 130 to 140 nm, thereby having a retardation Re value of λ/4.

### <Microscope Photograph in Black Luminance Evaluation>

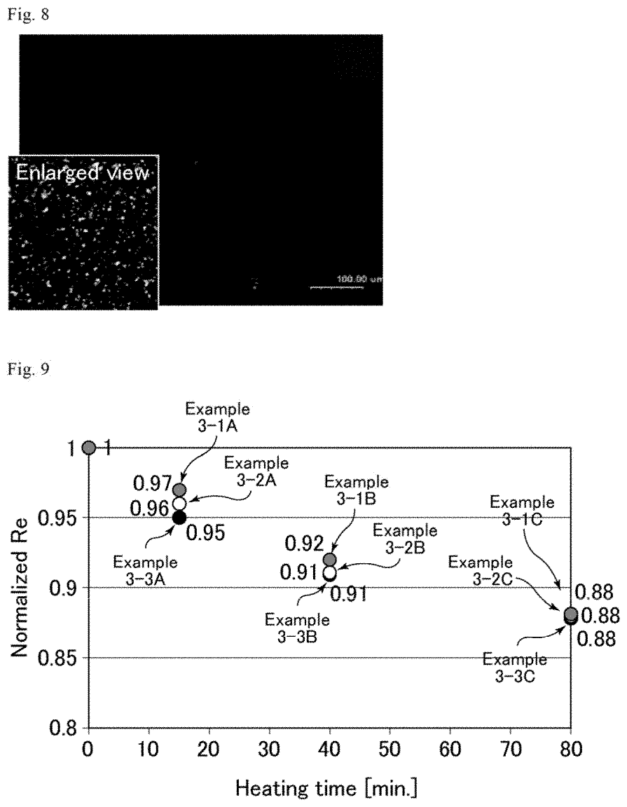

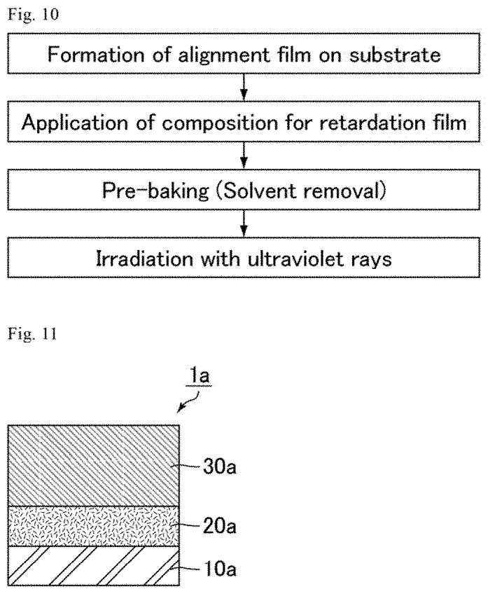

Microscope photographs of the retardation film 2-1 of Example 2-1 were taken before and after the second heating. The microscope photographs were taken in black luminance evaluation. FIG. 7 is a microscope photograph of the retardation film of Example 2-1 after the second heating. FIG. 8 is a microscope photograph of the retardation film of Example 2-1 before the second heating.

The microscope photographs shown in FIG. 7 and FIG. 8 both include white particles. These are presumably microdomains formed in the retardation giving layer. These particles are less likely to be observed after the second heating shown in FIG. 7 than before the second heating shown in FIG. 8. This means that, after the second heating, the alignment of microdomains was improved, whereby a retardation film with a high contrast ratio was obtained.

### [Retardation Films 2-2 to 2-5 of Examples 2-2 to 2-5]

Retardation films 2-2 to 2-5 of Examples 2-2 to 2-5 were produced as in Example 2-1 except that the thickness and the condition for the second heating in the retardation giving layer of Example 2-1 were changed as shown in Table 1. The thickness of the retardation giving layer was adjusted by changing the amount of the liquid crystal composition in the coating. Retardation giving layers with a thickness after removing the solvent of about 0.9 μm were formed with the amount of the liquid crystal composition of 2500 rpm/12 sec.

The retardation films 2-1 to 2-5 of Examples 2-1 to 2-5 after the second heating each had a retardation Re value of 133 nm. The retardation film 1-3B of Example 1-3B without the second heating also had a retardation Re value of 133 nm.

The contrast ratio of each of the retardation films of Examples 2-1 to 2-5 and Example 1-3B each having a retardation Re value of 133 nm was measured. Also, a CR increase ratio, which is a ratio of the contrast ratio after the second heating to the contrast ratio before the second heating, was calculated. The results are shown in Table 1. The difference in contrast ratio before the second heating between the retardation films 2-1 to 2-3 of Examples 2-1 to 2-3 is presumably due to the individual difference of the retardation films. The individual difference of the retardation films is, specifically, considered to be derived from a slight difference in thickness. The difference in contrast ratio before the second heating between the retardation films 2-4 and 2-5 of Examples 2-4 and 2-5 is also presumably due to the same reason.

TABLE 1

| | Coating thickness | | | | | | |
|---|---|---|---|---|---|---|---|
| | of retardation | | Retardation Re [nm] | | Contrast ratio (CR) | | |
| | giving layer | Condition for | Before second | After second | Before second | | |
| | [μ] | second heating heating | heating | heating | heating | After second | CR increase rate |
| Example 2-1 | 1.0 | 220° C./250 min. | 166 | 133 | 2938 | 4408 | 1.50 times |
| Example 2-2 | | 230° C./120 min. | | | 2825 | 4283 | 1.52 times |
| Example 2-3 | | 240° C./55 min. | | | 2639 | 4027 | 1.53 times |
| Example 2-4 | 0.9 | 220° C./70 min. | 153 | | 3117 | 3978 | 1.28 times |
| Example 2-5 | | 210° C./120 min. | | | 3054 | 3802 | 1.24 times |
| Example 1-3B | 0.8 | — | 133 | — | 3550 | — | — |

The CR increase ratio before and after the second heating is about 1.50 to 1.53 times in Examples 2-1 to 2-3. The CR increase ratio is about 1.24 to 1.28 times in Examples 2-4 and 2-5. Thus, the second heating improved the contrast ratio in each example.

Taking the retardation Re at 133 nm as a reference, the contrast ratios of Examples 2-1 to 2-3 after the second heating increased by about 1.25 times and the contrast ratios of Examples 2-4 and 2-5 after the second heating increased by about 1.12 times, compared with the contrast ratio (3550) of the retardation film of Example 1-3B without the second heating. Comparison with Example 1-3B showed that the increase in contrast ratio of the retardation films of Examples 2-1 to 2-5 results from performing the second heating as well as having small retardation Re values. The comparison also showed that the increase ratio of the contrast ratio of a retardation film increases as the heating temperature in the second heating increases and the heating time decreases.

### Example 3

### <Production of Retardation Films 3-1A to 3-1C of Examples 3-1A to 3-1C>

Retardation films 3-1A to 3-1C of Examples 3-1A to 3-1C were produced as in Examples 1-1A, 1-1C, and 1-1D except that the heating temperature in the heating was changed to 190° C.

### <Retardation of Retardation Films 3-1A to 3-1C of Examples 3-1A to 3-1C>

The obtained retardation films 3-1A, 3-1B, and 3-1C had normalized Re values of 0.97, 0.92, and 0.88, respectively. That is, the retardation Re values of the retardation films 3-1A, 3-1B, and 3-1C were reduced through the heating by 3%, 8%, and 12%, respectively.

### <Production of Retardation Films 3-2A to 3-2C of Examples 3-2A to 3-2C>

Retardation films 3-2A to 3-2C of Examples 3-2A to 3-2C were produced as in Examples 1-2A, 1-2C, and 1-2D except that the heating temperature in the heating was changed to 190° C.

### <Retardation of Retardation Films 3-2A to 3-2C of Examples 3-2A to 3-2C>

The obtained retardation films 3-2A, 3-2B, and 3-2C had normalized Re values of 0.96, 0.91, and 0.88, respectively. That is, the retardation Re values of the retardation films 3-2A, 3-2B, and 3-2C were reduced through the heating by 4%, 9%, and 12%, respectively.

### <Production of Retardation Films 3-3A to 3-3C of Examples 3-3A to 3-3C>

Retardation films 3-3A to 3-3C of Examples 3-3A to 3-3C were produced as in Examples 1-3A, 1-3C, and 1-3D except that the heating temperature in the heating was changed to 190° C.

### <Retardation of Retardation Films 3-3A to 3-3C of Examples 3-3A to 3-3C>

The obtained retardation films 3-3A, 3-3B, and 3-3C had normalized Re values of 0.95, 0.91, and 0.88, respectively. That is, the retardation Re values of the retardation films 3-3A, 3-3B, and 3-3C were reduced through the heating by 5%, 9%, and 12%, respectively.

FIG. 9 is a graph plotted with the normalized Re values of retardation films produced in Example 3 according to the heating time in the heating. The retardation films of Example 3 produced at a heating temperature of 190° C. had a decrease in retardation Re value by less than 12%, which was a smaller decrease in retardation Re value compared with the retardation films of Example 1 produced at a heating temperature of 210° C. The results from Examples 1 and 3 showed that a higher heating temperature achieves a larger decrease in retardation Re value and production of a retardation film excellent in retardation controllability in shorter time.

### [Additional Remarks]

An aspect of the present invention may be a method for producing a retardation film 1, including in the following order: fixing an alignment of liquid crystal compounds to form a retardation giving layer 30, and heating the retardation giving layer 30.

As mentioned, the method including the heating the retardation giving layer 30 after the fixing the retardation giving layer 30 enables production of a retardation film 1 excellent in retardation controllability against heat.

The heating may be performed to reduce the retardation Re of the retardation film 1 by 5% to 25%. This enables production of a retardation film 1 more excellent in retardation controllability against heat.

The heating may be performed at a temperature of 180° C. to 220° C. This enables production of a retardation film 1 more excellent in retardation controllability against heat.

The heating may be first heating, and the method for producing a retardation film may further include second heating for heating the retardation giving layer 30 after the first heating. This can increase the contrast ratio of the retardation film 1.

The second heating may be performed at a temperature not lower than the heating temperature in the first heating and not higher than 250° C. This can more increase the contrast ratio of the retardation film 1.

In the fixing, the liquid crystal compounds may be irradiated with light. This enables efficient fixing of the liquid crystal compounds at low temperatures.

The method for producing a retardation film may further include, before the fixing, coating a supporter with a liquid crystal composition containing the liquid crystal compounds. This enables production of retardation films 1 with desired optical properties using various liquid crystal compounds.

The method for producing a retardation film may further include, before the coating, alignment treating of the supporter. This can further improve the alignment of the liquid crystal compounds in the retardation giving layer 30.

The supporter may include a substrate 10 and a photoalignment film on the substrate 10, and the alignment treating may be performed on the photoalignment film. This enables alignment treatment without touching the surface of the photoalignment film, thereby reducing the waste generated by the alignment treatment.

The liquid crystal composition may further contain a solvent, and the method for producing a retardation film may further include removing the solvent between the coating and the fixing. This enables easier fixing of the liquid crystal compound.

Another aspect of the present invention may be a retardation film 1 produced by the method for producing a retardation film. As mentioned, a retardation film 1 produced by heating the retardation giving layer 30 after the fixing for forming the retardation giving layer 30 has excellent retardation controllability against heat.

The retardation film 1 may have a contrast ratio of not lower than 4000. This can further increase the contrast ratio of the liquid crystal display device.

The retardation film 1 may have a retardation Re of λ/4. This allows the retardation film 1 to convert linearly polarized light into circularly polarized light.

The retardation film 1 may include a substrate 10, an alignment film 20 on the substrate 10, and the retardation giving layer 30 on the alignment film 20. This can further improve the alignment of the liquid crystal compounds in the retardation giving layer 30.

The alignment film 20 may be a photoalignment film. This enables alignment treatment without touching the surface of the alignment film 20, thereby reducing the waste generated by the alignment treatment.

### REFERENCE SIGNS LIST

1, 1a: Retardation film
1b: Retardation film after first heating
1c: Retardation film after second heating
10: Substrate
10a: Supporter
20, 20a: Alignment film
30: Retardation giving layer
30a: Layer including composition for retardation film
31: Retardation giving layer before improving microdomain alignment
32: Retardation giving layer after improving microdomain alignment

1. A method for producing a retardation film, comprising in the following order:
fixing an alignment of liquid crystal compounds to form a retardation giving layer, and
heating the retardation giving layer.

2. The method for producing a retardation film according to claim 1,
wherein the heating is performed to reduce a retardation Re of the retardation film by 5% to 25%.

3. The method for producing a retardation film according to claim 1,
wherein the heating is performed at a temperature of 180° C. to 220° C.

4. The method for producing a retardation film according to claim 1,
wherein the heating is first heating, and
the method further includes second heating for heating the retardation giving layer after the first heating.

5. The method for producing a retardation film according to claim 4,
wherein the second heating is performed at a temperature not lower than the heating temperature in the first heating and not higher than 250° C.

6. The method for producing a retardation film according to claim 1,
wherein, in the fixing, the liquid crystal compounds are irradiated with light.

7. The method for producing a retardation film according to claim 1,
wherein the method further includes, before the fixing, coating a supporter with a liquid crystal composition containing the liquid crystal compounds.

8. The method for producing a retardation film according to claim 7,
wherein the method further includes, before the coating, alignment treating of the supporter.

9. The method for producing a retardation film according to claim 8,
wherein the supporter includes a substrate and a photoalignment film on the substrate, and
the alignment treating includes photoalignment treatment on the photoalignment film.

10. The method for producing a retardation film according to claim 7,
wherein the liquid crystal composition further contains a solvent, and
the method further includes removing the solvent between the coating and the fixing.

11. A retardation film produced by the method for producing a retardation film according to claim 1.

12. The retardation film according to claim 11, having a contrast ratio of not lower than 4000.

13. The retardation film according to claim 11, having a retardation Re of λ/4.

14. The retardation film according to claim 11, including a substrate, an alignment film on the substrate, and the retardation giving layer on the alignment film.

15. The retardation film according to claim 14,
wherein the alignment film is a photoalignment film.
